(19) United States
(12) Patent Application Publication
(10) Pub. No.: US 2025/0139723 A1
(43) Pub. Date: May 1, 2025

(54) PROGRESS TRACKING SYSTEM

(71) Applicant: CRIMSON CONSULTING LIMITED, Auckland (NZ)

(72) Inventors: Gabriel John GLADSTEIN, Van Nuys, CA (US); Henry James Peterson MELLSOP, Auckland (NZ); Zachary Lloyd WONG, Auckland (NZ)

(73) Assignee: CRIMSON CONSULTING LIMITED, Auckland (NZ)

(21) Appl. No.: 18/835,769

(22) PCT Filed: Feb. 3, 2023
(86) PCT No.: PCT/IB2023/050945

§ 371 Date: Aug. 5, 2024

(30) Foreign Application Priority Data
Feb. 4, 2022 (NZ) 784889

(51) Int. Cl. G06Q 50/20

(52) U.S. Cl. CPC G06Q 50/205

(57) ABSTRACT

A progress tracking system 100 for displaying progress of at least one student by way of a graphical user interface (GUI) is disclosed. The system 100 comprises a server 130 and at least one user device 110. The server 130 is configured to store information comprising at least an identity of the student, at least one goal of the student and progress data of the student towards achieving the goal. The user device 110 is configured to launch a progress tracking application that tracks the progress of the student towards the achievement the goal based on the progress data of that student. The progress tracking application generates and displays at least one indicator providing a visual indication of the progress of the student.

The present invention relates to a progress tracking system More particularly but not exclusively it relates to student progress tracking system.

### BACKGROUND OF THE INVENTION

The process of successfully obtaining admissions into educational institutions can not only be complex but can also be highly competitive. In some educational institutions, especially in the world's leading Universities, the acceptance process can be highly competitive.

Academic performance may be one of the critical components for gaining admissions into educational institutions. However, that is not necessarily the sole component, especially for gaining admission into some of the world's leading educational institutions. There may be several other components that potential candidates or students (hereinafter referred to as ‘students’) may need to focus on in order to enhance their chances of successfully gaining entry to their desired course of study in their desired educational institutions. Some non-limiting examples of such components are test scores (e.g. GPA®, SAT® and ACT® scores), letters of recommendation, essays, and extracurriculars. Competition is not necessarily limited to leading educational institutions. Gaining admissions into some averagely ranked educational institutions can be competitive, depending upon the location, faculty, course of study etc.

It can be challenging for the students to keep track of their progress to see how far they are from achieving their goals. Tracking progress allows students to identify the areas in which they are doing well or not so well, plan and prioritise towards achieving their goal(s), and if necessary or desired, re-adjust their goal(s). Similarly, it can be challenging for coaches (i.e., mentors or teachers) of the students to record the goals of their student and record and track progress of their students on different components so they can identify specific components or sub-components where the students need to work on in order to enhance their students' chances of successfully meeting their goals. Also, it can be challenging to provide feedback or communicate the results to each student to enable the students to identify the areas where they are doing well and areas where improvement and/or effort is required to achieve their goals. Doing all of this manually or using multiple tools can be time-consuming, inefficient and prone to error, especially if a high volume of students is involved.

### OBJECT OF THE INVENTION

It is an object of the present invention to provide a progress tracking system and/or apparatus which overcomes or at least partially ameliorates some of the abovementioned disadvantages, or which at least provides the public with a useful choice.

Alternately, it is an object of the present invention to provide a progress tracking method which overcomes or at least partially ameliorates some of the abovementioned disadvantages, or which at least provides the public with a useful choice.

### STATEMENTS OF INVENTION

In a first aspect, the present invention resides in a progress tracking system for displaying progress of at least one student by way of a graphical user interface (GUI), the system comprising:
a server configured to store information, the information comprising at least an identity of at least one student, at least one goal of the at least one student and progress data of the at least one student towards achieving the at least one goal,
at least one user device configured to launch a progress tracking application that is configured to:
   establish communication with the server via a network;
   input or facilitate input of the progress data of the at least one student;
   track progress of the at least one student towards the achievement of at least one goal based on the progress data of the at least one student; and
   execute the GUI to generate and display at least one indicator that provides visual indication of the progress of said at least one student.

In one embodiment, the progress tracking application is configured to input or facilitate input of the at least one goal of the at least one student.

In one embodiment, the progress tracking application is further configured to allow the progress data to be inputted as a selection of an option presented in the GUI.

In one embodiment, the at least one user device is a computer or a portable electronic handheld device.

In one embodiment, the at least one user device is a smartphone or a mobile electronic device.

In one embodiment, the progress tracking application is further configured to establish a connection with the server via a network.

In one embodiment, the progress tracking application is further configured to generate and present a plurality of progress levels that aligns with the at least one goal of the at least one student in the GUI.

In one embodiment, the progress tracking application is further configured to generate and present a plurality of progress levels, the progress levels correlating to progress towards the at least one goal of the at least one student in the GUI.

In one embodiment, the progress tracking application is further configured to generate and present at least five progress levels that aligns with the at least one goal of the at least one student in the GUI.

In one embodiment, each of the progress levels has an associated point value.

In one embodiment, the progress tracking application is further configured to record and present progress level information in the GUI, the progress level information relating to sequential progress of the at least one student from one level to another based on the point value.

In one embodiment, the progress tracking application is further configured to record and present progress level information in the GUI, the progress level information relating to sequential regress of the at least student from one level to another based on the point value.

In one embodiment, the at least one indicator is a progress bar.

In one embodiment, the progress tracking application is configured to present the progress level information as the progress bar.

In one embodiment, progress tracking application is further configured to present the sequential progress of the at least one student from one level to another in the GUI as the progress bar.

In one embodiment, the progress tracking application is further configured to present the sequential regress of the at least one student from one level to another is presented in the GUI as the progress bar.

In one embodiment, the progress tracking application is further configured allow an authorised user (e.g. a coach) to change the at least one goal.

In one embodiment, the progress tracking application is further configured to allow an or the authorised user to input progress data.

In one embodiment, the progress tracking application is further configured to prevent an unauthorised user (e.g. the at least one student) from updating progress data (e.g. assigning themselves a goal and/or giving themselves a point).

In one embodiment, the progress tracking application is configured to allow the at least one student to submit the at least one goal for review, preferably by an authorised person (e.g. the authorised user).

In one embodiment, the progress tracking application is further configured to display the identity of at least one student in the GUI.

In one embodiment, the progress tracking application is further configured to present overall points achieved by the at least one student in the GUI.

In one embodiment, the progress tracking application is further configured to display one or more of: the identity of the at least one student, overall progress achieved by the at least one student, remaining progress to be achieved by the at least one student to reach the at least one goal, a percentage value of the overall points achieved by the at least one student, and/or information regarding whether the at least one student is on or behind schedule to achieve the at least one goal within a given timeframe in the GUI.

In one embodiment, the progress tracking application is further configured to present total points yet to be achieved by the at least one student to reach the at least one goal in the GUI.

In one embodiment, the progress tracking application is further configured to present a percentage value of the overall points achieved by the at least one student in the GUI.

In one embodiment, the progress tracking application is further configured to present a percentage value of the overall points achieved by the at least one student in the GUI.

In one embodiment, the progress tracking application is further configured to present information regarding whether the at least one student is on or behind schedule to achieve the at least one goal within a given timeframe in the GUI.

In one embodiment, the progress tracking application is further configured to present a notification alert to a user of the user device in the GUI.

In one embodiment, the progress tracking application is further configured to generate a plurality of indices based on the progress of the at least one student, each of the plurality of indices having its own plurality of levels and each of plurality of levels of the indices having a point value associated with it.

In one embodiment, the progress tracking application is further configured to generate a plurality of indices based on areas that the at least one student needs to focus on, each of the plurality of indices having its own plurality of levels and each of plurality of levels of the indices having a point value associated with it.

In one embodiment, the progress tracking application is further configured to track progress with points, the GUI configured to display in the GUI at least one of: a total number of points that needs to be achieved for each of the at least one goals, total number of points already achieved for each of the at least one goals, and/or, a percentage value of the total number of points achieved for each of the at least one goals.

In one embodiment, at least one indicator provides a visual indication of the progress of the at least one student for each of the at least one goals.

In one embodiment, the progress tracking application is further configured to present at least one of the total number of points that needs to be achieved for each of the plurality of indices, total number of points achieved so far for each of the indices and percentage value of total number of points achieved for each of the indices in the GUI.

In one embodiment, there are five indices.

In one embodiment, the at least one indicator provides a visual indication of the progress of the at least one student for each of the different indices.

In one embodiment, the progress tracking application is further configured to generate a report, the report comprising at least the information and/or summary of the progress of the at least one student.

In one embodiment, the progress tracking application is further configured to electronically send the report to at least one second user device.

In a second aspect, the present invention resides in a computer implemented method for displaying progress of at least one student by way of a graphical user interface (GUI) of an electronic apparatus comprising a display device, a processor and a memory, the method comprising:
inputting progress data of the at least one student using the apparatus;
tracking progress of the at least one student towards the at least one goal based on the progress data of the at least one student; and
executing the GUI and generating and displaying at least one indicator on the display device providing visual indication of the progress of the at least one student.

In one embodiment, the electronic device is configured to launch a progress tracking application and the method steps are performed by a progress tracking application.

In one embodiment, the method comprises, inputting at least one goal of the at least one student using the apparatus.

In one embodiment, the method further comprises allowing the progress data to be inputted as a selection of an option presented in the GUI.

In one embodiment, the step of the inputting the progress data comprises at least one selection of a plurality of options presented in the GUI

In one embodiment, the apparatus is a computer or a portable electronic handheld device.

In one embodiment, the apparatus is a smartphone or a mobile electronic device.

In one embodiment, the method further comprises establishing a connection with a server via a network, the server being configured to store information, the information comprising at least an identity information of the at least one student, the at least one goal of the at least one student and the progress data of the at least one student towards achieving the at least one goal.

In one embodiment, the method further comprises generating and presenting (displaying) a plurality of progress levels that aligns with the at least one goal of the at least one student in the GUI.

In one embodiment, the method further comprises generating and presenting a plurality of progress levels, the progress levels correlating to progress towards the at least one goal of the at least one student in the GUI.

In one embodiment, the method further comprises generating and presenting at least five levels that aligns with the at least one goal of the at least one student in the GUI.

In one embodiment, the method further comprises associating a point value to each of the progress levels.

In one embodiment, the method further comprises recording and presenting progress level information in the GUI, the progress level information relating to sequential progress of the at least one student from one level to another based on the point value.

In one embodiment, the method further comprises recording and presenting information in the GUI, the information relating to sequential regress of the at least one student from one level to another based on the point value.

In one embodiment, the at least one indicator is a progress bar.

In one embodiment, the method comprises presenting the progress level information as the progress bar.

In one embodiment, the method further comprises presenting the sequential progress of the at least one student from one level to another in the GUI as the progress bar.

In one embodiment, the method further comprises presenting the sequential regress of the at least one student from one level to another is presented in the GUI as the progress bar.

In one embodiment, the method further comprises allowing an authorised user (e.g. a coach) to change the at least one goal.

In one embodiment, the method further comprises allowing an or the authorised user to input progress data (e.g. assigning themselves a goal and/or updating progress data). In one embodiment, the method further comprises preventing an unauthorised user (e.g. the at least one student) from assigning themselves a goal and/or giving themselves a point.

In one embodiment, the method further comprises allowing the at least one student to submit the at least one goal for review, preferably by an authorised user (e.g. the authorised person).

In one embodiment, the method further comprises presenting identity of the at least one student in the GUI.

In one embodiment, the method further comprises presenting overall points achieved by the at least one student in the GUI.

In one embodiment, the method further comprises presenting total points yet to be achieved by the at least one student to reach the at least one goal in the GUI.

In one embodiment, the method further comprises presenting a percentage value of the overall points achieved by the at least one student in the GUI.

In one embodiment, the method further comprises presenting information regarding whether the at least one student is on or behind schedule to achieve the at least one goal within a given timeframe in the GUI.

In one embodiment the method further comprises displaying one or more of: the identity of the at least one student, overall progress achieved by the at least one student, remaining progress to be achieved by the at least one student to reach the at least one goal, presenting a percentage value of the overall points achieved by the at least one student in, and/or information regarding whether the at least one student is on or behind schedule to achieve the at least one goal within a given timeframe in the GUI.

In one embodiment, the method further comprises generating a plurality of indices based the progress of the at least one student, each of the plurality of indices having its own plurality of levels and each of plurality of levels of the indices having a point value associated with it.

In one embodiment, the method further comprises presenting a notification alert in the GUI.

In one embodiment, the method further comprises generating a plurality of indices based on areas that the at least one student needs to focus on, each of the plurality of indices having its own plurality of levels and each of plurality of levels of the indices having a point value associated with it.

In one embodiment, the method further comprises tracking progress with points, and displaying in the GUI at least one of: a total number of points that needs to be achieved for each of the at least one goals, total number of points already achieved for each of the at least one goals, and/or a percentage value of total number of points achieved for each of the at least one goals.

In one embodiment, the method further comprises providing a visual indication of the progress of the at least one student for each of the at least one goals.

In one embodiment, the method further comprises presenting at least one of the total number of points that needs to be achieved for each of the plurality of indices, total number of points achieved so far for each of the indices and percentage value of total number of points achieved for each of the indices in the GUI.

In one embodiment, there are five indices.

In one embodiment, the method further comprises providing a visual indication of the progress of the at least one student for each of the different indices.

In one embodiment, the method further comprises generating a report, the report comprising at least the stored information and/or summary of the progress of the at least one student.

In one embodiment, the method further comprises electronically sending the report to at least one second device.

In a third aspect, the present invention resides in an apparatus for displaying progress of at least one student by way of a graphical user interface (GUI), the apparatus comprising:
a display device;
a processor; and
a memory storing computer readable instructions that when executed, cause the apparatus to:
   input progress data of the at least one student;
   track progress of the at least one student towards the at least one goal based on the progress data of the at least one student; and
   execute the GUI that generates and displays at least one indicator on the display device providing visual indication of the progress of the at least one student.

In one embodiment, the apparatus is further configured to input at least one goal of the at least one student.

In one embodiment, the apparatus is further configured to allow the progress data to be inputted as a selection of an option presented in the GUI.

In one embodiment, the apparatus is a computer or a portable electronic handheld device.

In one embodiment, the apparatus is a smartphone or a mobile electronic device.

In one embodiment, the apparatus is further configured to establish a connection with a server via a network, the server being configured to store information, the information comprising at least an identity information of the at least one student, the at least one goal of the at least one student and the progress data of the at least one student towards achieving the at least one goal.

In one embodiment, the apparatus is further configured to generate and present a plurality of progress levels that aligns with the at least one goal of the at least one student in the GUI.

In one embodiment, the apparatus is further configured to generate and present at least five progress levels that aligns with the at least one goal of the at least one student in the GUI.

In one embodiment, the progress tracking application is further configured to generate and present a plurality of progress levels, the progress levels correlating to progress towards the at least one goal of the at least one student in the GUI.

In one embodiment, each of the progress levels has an associated point value associated with it.

In one embodiment, the apparatus is further configured to record and present progress level information in the GUI, the progress level information relating to sequential progress of the at least one student from one level to another based on the point value.

In one embodiment, the apparatus is further configured to record and present progress level information in the GUI, the progress level information relating to sequential regress of the at least one student from one level to another based on the point value.

In one embodiment, the at least one indicator is a progress bar.

In one embodiment, the progress tracking application is configured to present the progress level information as the progress bar.

In one embodiment, the apparatus is further configured to present the sequential progress of the at least one student from one level to another in the GUI as the progress bar.

In one embodiment, the apparatus is further configured to present the sequential regress of the at least one student from one level to another is presented in the GUI as the progress bar.

In one embodiment, the apparatus is further configured to allow an authorised user (e.g. a coach) to change the at least one goal.

In one embodiment, the apparatus is further configured to allow an or the authorised user to input progress data.

In one embodiment, the apparatus is further configured to prevent an unauthorised user (e.g. the at least one student) from updating progress data (e.g. assigning themselves a goal and/or giving themselves a point).

In one embodiment, the apparatus is configured to allow the at least one student to submit the at least one goal for review, preferably by an authorised person (e.g. the authorised user).

In one embodiment, the apparatus is further configured to display identity of at least one student in the GUI.

In one embodiment, the apparatus is further configured to present overall points achieved by the at least one student in the GUI.

In one embodiment, the progress tracking application is further configured to display one or more of: the identity of the at least one student, overall progress achieved by the at least one student, remaining progress to be achieved by the at least one student to reach the at least one goal, a percentage value of the overall points achieved by the at least one student, and/or information regarding whether the at least one student is on or behind schedule to achieve the at least one goal within a given timeframe in the GUI

In one embodiment, the apparatus is further configured to present total points yet to be achieved by the at least one student to reach the at least one goal in the GUI.

In one embodiment, the apparatus is further configured to present a percentage value of the overall points achieved by the at least one student in the GUI.

In one embodiment, the apparatus is further configured to present information regarding whether the at least one student is on or behind schedule to achieve the at least one goal within a given timeframe in the GUI.

In one embodiment, the apparatus is further configured to present a notification alert in the GUI.

In one embodiment, the progress tracking application is further configured to generate a plurality of indices based on the progress of the at least one student, each of the plurality of indices having its own plurality of levels and each of plurality of levels of the indices having a point value associated with it.

In one embodiment, the apparatus is further configured to generate a plurality of indices based on areas that the at least one student needs to focus on, each of the plurality of indices having its own plurality of levels and each of plurality of levels of the indices having a point value associated with it.

In one embodiment, the progress tracking application is further configured to track progress with points, the GUI configured to display in the GUI at least one of: a total number of points that needs to be achieved for each of the at least one goals, total number of points already achieved for each of the at least one goals, and/or, a percentage value of the total number of points achieved for each of the at least one goals.

In one embodiment, at least one indicator provides a visual indication of the progress of the at least one student for each of the at least one goals

In one embodiment, the apparatus is further configured to present at least one of the total number of points that needs to be achieved for each of the plurality of indices, total number of points achieved so far for each of the indices and percentage value of total number of points achieved for each of the indices in the GUI.

In one embodiment, there are five indices.

In one embodiment, the at least one indicator provides a visual indication of the progress of the at least one student for each of the different indices.

In one embodiment, the apparatus is further configured to generate a report, the report comprising at least the information and/or summary of the progress of the at least one student.

In one embodiment, the apparatus is further configured to electronically send the report to at least one second device.

In a fourth aspect, the present invention resides in a non-transitory computer program product embodied on a non-transitory computer readable medium, said computer program product comprising a program logic, which when executed on at least one computer processor perform a method of displaying a progress of at least one student by way of a graphical user interface (GUI) of an electronic apparatus comprising a display device, a processor and a memory, the method comprising:
inputting at least one goal of the at least one student using the apparatus;
inputting progress data of the at least one student using the apparatus;
tracking progress of the at least one student towards the at least one goal based on the progress data of the at least one student; and
executing the GUI and generating and displaying at least one indicator on the display device providing visual indication of the progress of the at least one student.

One or more statements as defined above in relation to the second aspect of the invention may equally apply to the invention described above in the fourth aspect.

One or more statements as defined above in relation to one aspect of the invention may equally apply to the invention described above in another aspect.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, any reference to such external documents is not to be construed as an admission that such documents, or such sources of information, in any jurisdiction, are prior art, or form part of the common general knowledge in the art.

For the purpose of this specification, where method steps are described in sequence, the sequence does not necessarily mean that the steps are to be chronologically ordered in that sequence unless there is no other logical manner of interpreting the sequence.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for the inclusion of not only the listed components or elements but also other non-specified components or elements. The terms ‘comprises’ or ‘comprised’ or ‘comprising’ have a similar meaning when used in relation to the apparatus, system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’ or ‘configured’ for the purpose that is stated.

Unless specifically stated otherwise, in this specification, use of the word ‘substantially’ with a term, to define a characterizing feature(s), gets all the benefit (i.e. benefit of any broadening) afforded by the use of the word ‘substantially’, and also includes within its scope the feature(s) being that term exactly, (without broadening). For example, if a feature is described/defined in the present specification as being ‘substantially orthogonal’ then that includes, within its scope, the feature being ‘close’ to orthogonal (in so far the word ‘substantially’ is deemed to broaden the term ‘orthogonal’), and also includes within its scope the feature being ‘exactly’ orthogonal.

App is a software application for a portable electronic handheld device or a mobile device such as a smartphone that is carried by a person.

Application Programming Interface (API) is a collection of computer software code, usually a set of class definitions, that can perform a set of related complex tasks, but has a limited set of controls that may be manipulated by other software-code entities. The set of controls is deliberately limited for the sake of clarity and ease of use, so that programmers do not have to work with the detail contained within the given API itself.

### BRIEF DESCRIPTION OF THE DRAWINGS

The invention will now be described by way of example only and with reference to the drawings in which:

FIG. 1: shows a schematic diagram showing one example of a device that can be used to perform various embodiments of the invention.

FIG. 2A: shows a schematic flow diagram of a working principle of the overall system according to one example of the present invention.

FIG. 2B: shows a flowchart showing an example of a method of conducting the present invention

FIGS. 3-5: shows on-screen displays according to one example of the present invention.

### DETAILED DESCRIPTION

It is desirable to have a reliable and robust progress tracking system that helps strategists such as mentors and coaches (e.g. teachers) to map out intermediate goals for the students who are seeking admissions to one or more educational institutions and/or one or more courses of study, leading up to the application cycle and to track their progress along the way.

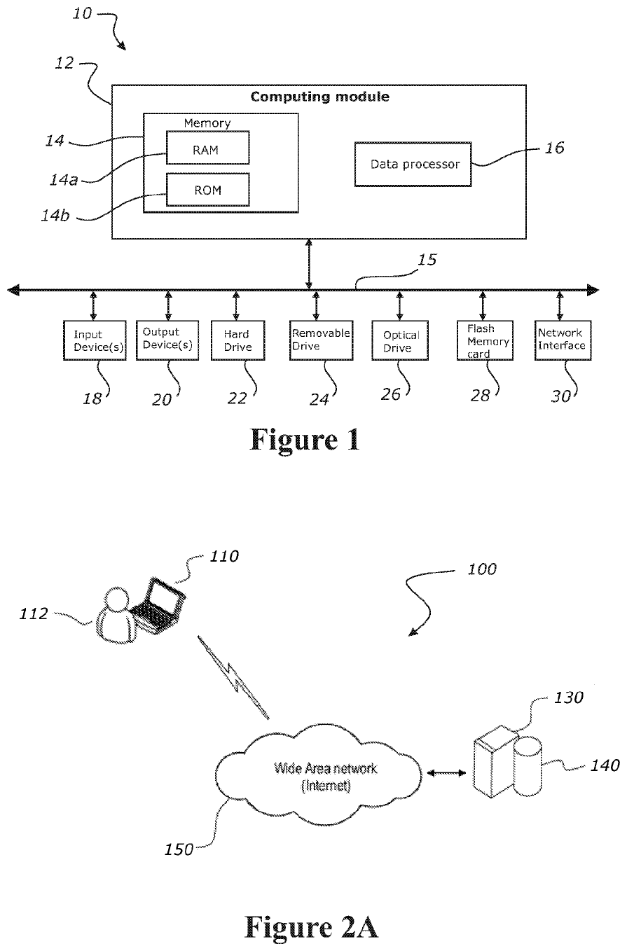

FIG. 1 shows one example of a device/apparatus in the form of the computer 10 that can be used to perform various embodiments of the invention. As shown, device 10 may have computing module 12. The computing module 12 may comprise a memory 14 and a data processor 16. The data processor 16 may be of any suitable type of device for executing software instructions such as but not limited to a microprocessor device. Memory 14 may include a random access memory (RAM) 14a and a read-only memory (ROM) 14b. As will be appreciated by those of ordinary skill in the art, both the random access memory (RAM) 14a and read-only memory (ROM) 14b may store software instructions that may be executed using the data processor 16.

The memory 14 and/or the data processor 16 may be connected, either directly or indirectly, through a bus 15 or any other suitable means to one or more peripheral devices. Memory 14 and/or the data processor 16 may be directly or indirectly connected to at least one input device 18 such as but not limited to a keyboard, touch screen, a mouse, a touchpad, a stylus, a scanner, a camera or a microphone. Similarly, the memory 14 and/or the data processor 16 may be directly or indirectly connected to at least one output device(s) 20 such as but not limited to a display monitor/screen, haptic feedback device, printer or a speaker.

The memory 14 and/or processor 16 may be operatively connected to additional one or more storage device(s), such as but limited to the hard drive 22, the removable drive 24, the optical disk drive 26, and/or the flash memory card 28.

The computing unit 15 may be directly or indirectly connected to at least one network interface 30 (e.g. a network adapter or a network interface card (NIC)) for communicating with a network. The network interface 30 may translate data and control signals from the computing module 12 into network messages according to one or more communication protocols, such as the Transmission Control Protocol (TCP), the Internet Protocol (IP), and the User Datagram Protocol (UDP). These protocols will be well known to a person skilled in the art therefore need not be described detail. The network interface 30 may employ any suitable connection agent for connecting to a network, including, for example, a wireless transceiver, a power line adapter, a modem, or an Ethernet connection.

Computer 10 may optionally include, for example, at least one communication ports through which a peripheral device can be connected to the computing module 12 (either directly or indirectly through bus 15). Some non-limiting examples of such communication ports are a parallel bus port, a serial bus port, the Universal Serial Bus (USB) standard port etc. The communication ports may thus include a parallel bus port or a serial bus port. Alternatively or additionally, the computer 10 may include a wireless data “port,” such as but not limited to a Bluetooth interface, a Wi-Fi interface, an infrared data port, or a combination thereof.

Computer 10 may include more or fewer components than what is described above. In some embodiments, computer 10 may be of a specific type of computer e.g. smartphone, PDA, tablet or the like in which case unnecessary peripheral devices, such as printers, scanners, external hard drives etc. may not be present. Alternatively, or additionally, in some embodiments, the computer 10 may be intended to be capable of a wide variety of functions, such as a desktop or laptop personal computer. The computer 10 may have any combination of peripheral devices or additional components as desired.

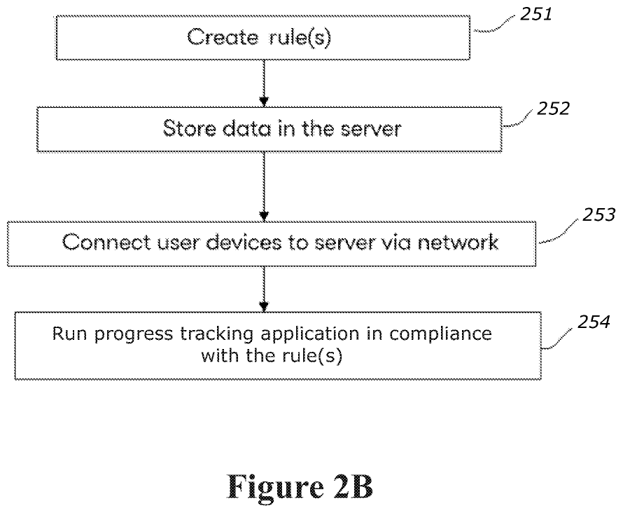

A progress tracking system according to an embodiment of the present invention is generally indicated by the numeral 100 will now be described with reference to FIG. 2a.

As shown, system 100 may comprise at least one user device 110 (client device) and a server 130. The user device 110 may be the same as the computer 10 described above. Server 130 may be a remote server (e.g. a cloud server) to which the user device 110 may be connected via a network 150, e.g. internet. Server 130 may store information comprising at least an identity/identification information of at least one student and at least one goal of the student(s) and progress data of the student(s) towards achieving that goal. In certain embodiments, such information may be stored within the memory of the user device 110 itself.

The user device 110 may establish the communication with the server via a network for inputting the progress data and executing the Graphical User Interface (GUI) to launch and display at least one indicator that provides a visual indication of the progress of the student(s). In order to do that, the user device 110 may be configured to launch a progress tracking application that may be configured to establish communication with server 130 via a network. Progress tracking application may be configured to input or facilitate input of the goal(s) and the progress data of the student(s). Alternatively, the goal(s) may be pre-set goal(s) in which case the progress tracking application need not input or facilitate input of the goal(s). Progress tracking application may allow coach 112 to make such inputs. Progress tracking application may then track the progress of the student(s) towards the achievement of the goal(s) based on the progress data of the student(s). Progress tracking application may then execute the GUI to generate and display at least one indicator that provides a visual indication of the progress of the student(s). In some embodiments, the user device 110 may itself execute the GUI that generates and displays at least one indicator on a screen/display device providing a visual indication of the progress of the student(s). Although FIG. 2A only shows one user device 110, there may be multiple user devices, each working in similar or substantially the same way as user device 110. Some of the user device 110 may be running a student version of the progress tracking application in which case the user 112 of such a user device may be the student(s). The student version of the progress tracking application will be described later in this specification.

In some embodiments, the user device 110 may input the progress data and execute the Graphical User Interface (GUI) to launch and display at least one indicator that provides a visual indication of the progress of the student(s) according to one or more rule(s) defined by the progress tracking application. In certain embodiments, such rule(s) may be stored on server 130. The rule(s) may be pre-determined, preferably by the coach or the organisation or service provider (e.g. training academy, school, educational institute etc.) with which the coach is associated/affiliated.

FIG. 2B shows an example of a method of conducting the present invention. At step 251, one or more rule(s) are created. The rule(s) may be defined by the progress tracking application. The second step 252 may include storing data in server 130 (or server database 140) as described above. The third step 253 may include connecting user device(s) to server 130 via a network 150. The fourth step 254 involves running the progress tracking application using the user device(s) in compliance with the rule(s) created in step 251.

The progress tracking application may be a software application (e.g. a mobile app) or software tool/program or computer readable instructions which when executed may perform several functions. The user device 110 may run the progress tracking application in compliance with the rule(s). In certain embodiments, at least part of the software application may be a cloud application running in the server 130. The user device 110 may access the cloud application via a network. In one non-limiting example, the user device 100 may access the cloud application via a network using APIs.

In some embodiments, the rule(s) may dictate/define what information is to be communicated from server 130 to the user device 110 to be displayed by the user device 110. This may include displaying of at least one indicator that provides a visual indication of the progress of the student(s). The rule(s) may or may also dictate what information is to be communicated from the user device 110 to the server 130.

The process may begin at a level (progress level) that the student needs to aim for that aligns with where the student intends to gain admission. Here the student may be a current high school student who is planning to attend an educational institution after finishing high school in the next year or next few years (e.g. next 1-3 years). Alternatively, the student may be someone who has already finished high school but is yet to meet some of the minimum requirements (e.g. extracurricular activity(ies) or test(s)) necessary to maximise their chances of successfully achieving their goal of attending a particular educational institution for further studies.

The progress tracking application may be configured to generate and present a plurality of progress levels, the progress levels correlating to progress towards the at least one goal of the at least one student in the GUI. There may be a total of five levels (progress levels). Each of those levels may have a point value associated with it. These levels and the points values associated with those levels may correlate with the admission requirements of various educational institutions. Every student may start by choosing a level to aim that aligns with their goal of attending a particular educational institution for further studies. Every student may start as a Scout. The student may sequentially progress from the initial level of Scout to higher levels based on their point value. The sequence of levels from the lowest to the highest in this example is Scout, Seeker, Venturer, Voyager and Globetrotter. There may be less than five or more than five levels. Similarly, the names of the levels are given by way of examples only and any suitable names may be given to each level. The goal(s) of the student may be different from what is described herein. For example, the goal of the student may be to gain entry into a particular course of study within a particular educational institution.

As mentioned before, each level may align with what the goal(s) of the student is/are, which in this example is where the student intends to gain admission. By way of example only, if the student intends to gain admission in one or more of the top 15 educational institutions in the United States where the admission is most competitive, the goal for that student may be to reach Globetrotter level to maximise their chances of success. Similarly, if the student wishes to maximise their chance of attending the educational institutions ranked between 15 to 30 or between 16 to 30, they may need to aim to reach the Voyager level. If the student wishes to maximise their chance of attending the educational institutions ranked between 30 to 50 or between 31 to 50, they may need to aim to reach the Venturer level. Similarly, if the student wishes to maximise their chance of attending the educational institutions ranked beyond 50, they may need to aim to reach the Venturer or Seeker level. Achieving these levels may not necessarily guarantee the admissions for the students but it may still provide indication on how likely their chances of success is. The higher a student scores, more competent that student will be, and consequently more likely that student will increase the chances of success.

If the user 112 is a coach, the coach 112 may begin by setting a goal or goals with the student. The goal(s) may be changed later on if the student's ambitions change or if the original goal seems too difficult or too easy or for whatever other reason. Once the goal(s) is/are set up, coach 112 may then input the start date and select the student's application year.

If the student has already accomplished a particular goal or a particular level, then the progress tracking application may allow the coach 112 to input that information. In some embodiments, the progress data of the student may be inputted as a selection of an option that is presented in the GUI.

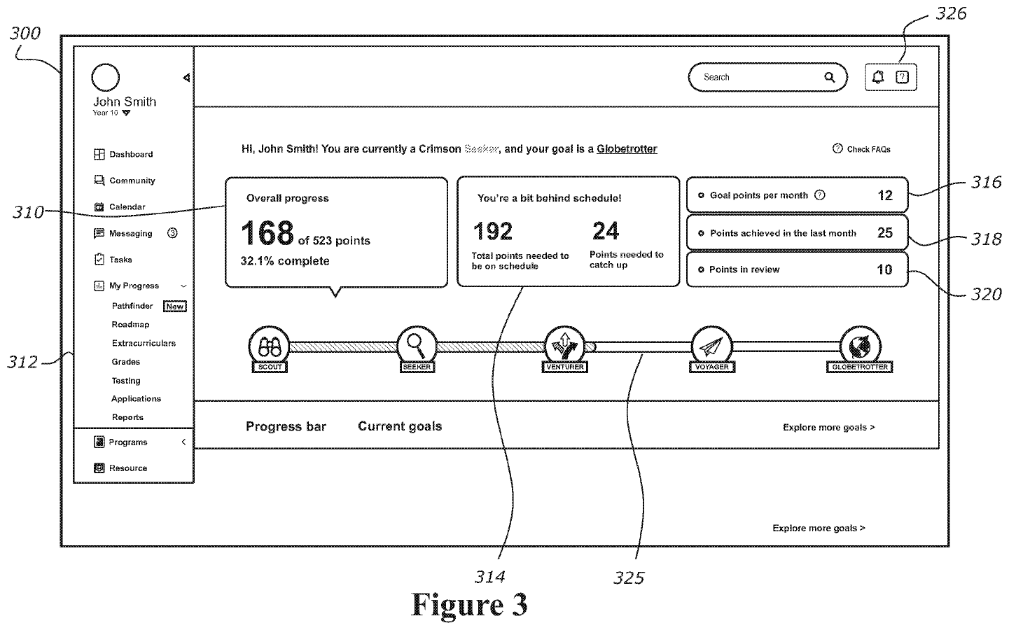

In some embodiments, the progress tracking application may be configured to record and present information (progress level information) relating to the sequential progress (or sequential regress) of the student from one level to another based on the point value. As shown in FIG. 3, the overall progress of the student may be presented in the GUI 300. GUI 300 may present the identity of the student and several options in area 312. Overall progress card 310 may display the student's overall progress (e.g. overall points) including remaining progress to be achieved by the student (i.e. the total points that are yet to be achieved by the student) to reach their goal(s). The percentage value of the overall points achieved by the student may also be displayed as shown. A further card 314 may display information regarding whether the student is on or behind schedule to achieve their goal(s) within a given timeframe. For example, if the student is due to achieve a particular point value within a particular date and has not yet achieved that point within that date, card 314 may display information warning student that the student is behind schedule together with total number of points to be on schedule as well as total number of points needed to catch up. The GUI 300 may also display information regarding the goal points per month at card 316, points achieved in the last month at card 318 and points that is currently being reviewed by the coach at card 320.

In some embodiments, the GUI may generate and display at least one indicator on a screen providing a visual indication of the progress of at least one student. As shown, the indicator may be in the form of a progress bar 325 displaying the overall progress of the student. Additionally, or alternatively, many other suitable indicators providing an indication of the progress of student(s) is possible such as but not limited to graphs, charts etc.

In some embodiments, a notification bell icon 326 may provide an alert on any notifications to the user of the user device

In some embodiments, the progress tracking application may provide a breakdown of a plurality of indices based on the progress of the student(s) (the areas that the student(s) needs to focus on. Each of these indices may have its own levels, and each of those levels may have a point value associated with it. For example, the progress tracking application may provide a breakdown of five indices, namely, Academics, Standardized Tests, Personal Development, Extracurriculars, and Major, Careers, and School Research. Each of these indices may be weighted differently according to what matters most for admission into an educational institution(s). For example, Academics may have a weighting of 35%, Standardized Tests (e.g. IELTS®, TOEFL®, SAT®, GPA®, ACT® etc.) may have a weighting of 15%, Personal Development may have a weighting of 20%, Extracurriculars may have a weighting of 20% and Majors, Careers and School Research may have a weighting of 10%. These weightings/percentage values provided above are most preferable, however in some embodiments, they may be different. Similarly, the number and types of indices provided above are most preferable, however in some embodiments, they may be different. Therefore, in some embodiments, these are non-limiting examples.

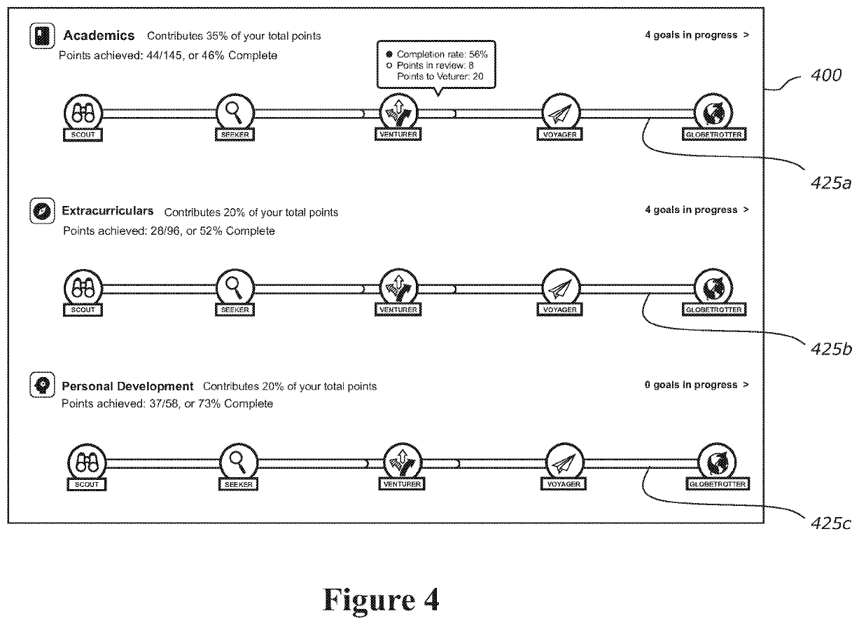

As shown in FIG. 4, in some embodiments, the GUI 400 may generate and display at least one indicator on a screen providing a visual indication of the progress of the student(s) for each of the different indices. As shown, the indicator may be in the form of progress bars 425a, 425b and 425c displaying the progress of the student for each of the indices Additionally or alternatively, many other suitable indicators providing indication(s) of the progress of the at least one student are possible such as, but not limited to graphs, charts etc. Information regarding the total number of points that needs to be achieved for each of the indices, the total number of points achieved so far for each of the indices and percentage value of the total number of points achieved for each of the indices may also be displayed by the GUI 400. Although FIG. 4 only shows information on three of the five indices being displayed on the GUI, all of the five indices may be displayed by GUI 300. Preferably, GUI 400 is part of GUI 300 and is visible by scrolling down on GUI 300. Therefore, the progress tracking application may be configured to track progress with points. The GUI may be configured to display in the GUI at least one of: a total number of points that needs to be achieved for each of the goal(s), total number of points already achieved for each of goal(s), and/or a percentage value of the total number of points achieved for each of the goal(s).

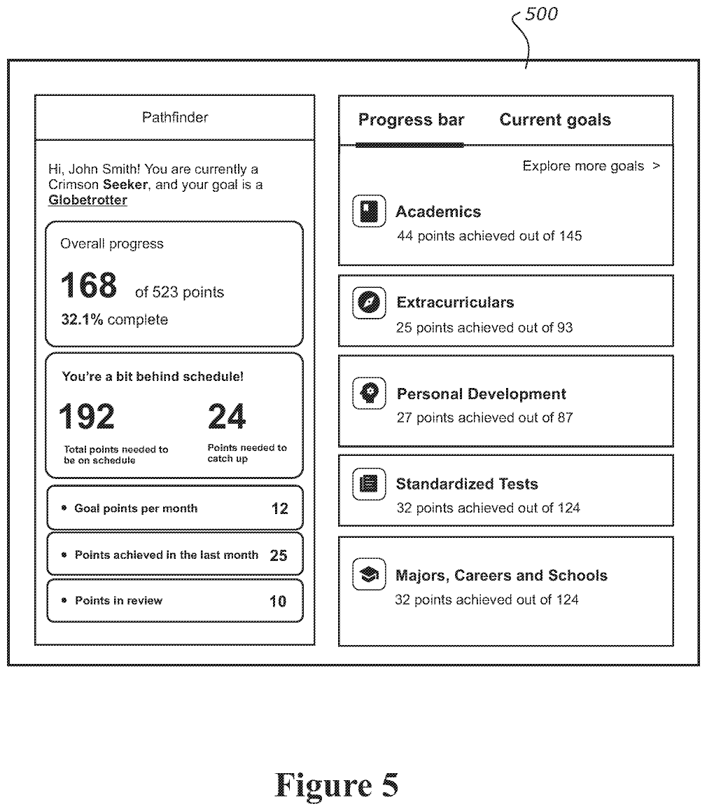

FIG. 5 shows an example of how the progress tracking application may display a student's overall progress with breakdown of the progress of each of the indices or goal(s) in a single GUI 500.

The student version of the progress tracking application running on a user device of the student(s) may be like the normal version as described above, but it may not allow students to assign the goals and/or to update progress data (e.g. give themselves a point). In some embodiments, the student version of the progress tracking application may allow student(s) to submit their goals for review by the coaches when they believe that they have completed one.

Therefore, it can be appreciated that the present invention allows mapping out a goal(s) for the students and allows both the coaches and the students to see the progress of the student in real time. The progress tracking application may not allow students to assign the goals and/or give themselves a point. In some embodiments, the progress tracking application may allow students to submit their goals for review by the coaches when they believe that they have completed one. The progress tracking application may allow the coaches to review any goal(s) a student has marked when they log in. The notification bell icon 226 may alert the coaches if there is any new notification since they last logged.

In some embodiments, the progress tracking application may be configured to electronically send the report to at least one second user device. The second user device may be similar or substantially the same as the user device 110 as described above. In one example, the report to be accessed by the student(s). Such report may contain information about the student(s) progress. In such a case, the second user device may be used by the student(s) who can then access the report sent by the first user device.

As it can be appreciated, the present invention provides several advantages. Some non-limiting advantages of the present invention may include:
It can enable the coaches and students to track the progress over time.
It can enable students to identify if they are on track with achieving their goals and any areas that need improvement.
It can enable the students to determine if they are over presented or underrepresented in any of the indices.
It can provide an interactive platform to visualise whether students are behind or on schedule, points scored within specific interval of time (e.g. per month) etc.
It can enable a user to view progress in session by session.
It can enable student(s) to reset their goals, if required or desired.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A progress tracking system for displaying progress of at least one student by way of a graphical user interface (GUI), the system comprising:
a server configured to store information, the information comprising at least an identity of at least one student, at least one goal of the at least one student and progress data of the at least one student towards achieving the at least one goal, and
at least one user device configured to launch a progress tracking application that is configured to:
establish communication with the server via a network;
input or facilitate input of the progress data of the at least one student; and
track progress of the at least one student towards the achievement of at least one goal based on the progress data of the at least one student; and
execute the GUI to generate and display at least one indicator that provides visual indication of the progress of said at least one student.

2. The progress tracking system of claim 1, wherein the progress tracking application is further configured to input or facilitate input of the at least one goal of the at least one student.

3. The progress tracking system of claim 1, wherein the progress tracking application is further configured to establish a connection with the server via a network, the server being configured to store information.

4. The progress tracking system of any one of claims 1 to 3, wherein the progress tracking application is further configured to generate and present a plurality of progress levels, the progress levels correlating to progress towards the at least one goal of the at least one student in the GUI.

5. The progress tracking system of claim 4, wherein each of the progress levels has an associated point value.

6. The progress tracking system of claim 5, wherein the progress tracking application is further configured to record and present progress level information in the GUI, the progress level information relating to sequential progress or sequential regress of the at least one student from one level to another based on the point value.

7. The progress tracking system of claim 6, wherein the at least one indicator is a progress bar and the progress tracking application is configured to present the progress level information as the progress bar.

8. The progress tracking system of any one of claims 1 to 7, wherein the progress tracking application is further configured allow an authorised user to change the at least one goal.

9. The progress tracking system of any one of claims 1 to 8, wherein the progress tracking application is further configured to allow an or the authorised user to input progress data.

10. The progress tracking system of any one of claims 1 to 8, wherein the progress tracking application is further configured to prevent an unauthorised user from assigning themselves a goal and/or updating progress data.

11. The progress tracking system of any one of claims 1 to 9, wherein the progress tracking application is configured to allow the at least one student to submit the at least one goal for review.

12. The progress tracking system of any one of claims 1 to 8, wherein the progress tracking application is further configured to display the identity of the at least one student in the GUI.

13. The progress tracking system of any one of claims 1 to 12, wherein the progress tracking application is further configured to display one or more of: the identity of the at least one student, overall progress achieved by the at least one student, remaining progress to be achieved by the at least one student to reach the at least one goal, a percentage value of the overall points achieved by the at least one student, and/or information regarding whether the at least one student is on or behind schedule to achieve the at least one goal within a given timeframe in the GUI.

14. The progress tracking system of any one of claims 1 to 13, wherein the progress tracking application is further configured to present a notification alert to a user of the user device in the GUI.

15. The progress tracking system of any one of claims 1 to 14, wherein the progress tracking application is further configured to generate a plurality of indices based on the progress of the at least one student, each of the plurality of indices having its own plurality of levels and each of plurality of levels of the indices having a point value associated with it.

16. The progress tracking system of any one of claims 1 to 15, wherein the progress tracking application is further configured to track progress with points, the GUI configured to display in the GUI at least one of: a total number of points that needs to be achieved for each of the at least one goals, total number of points already achieved for each of the at least one goals, and/or a percentage value of the total number of points achieved for each of the at least one goals.

17. The progress tracking system of any one of claims 1 to 16, wherein the at least one indicator provides a visual indication of the progress of the at least one student for each of the at least one goals.

18. The progress tracking system of any one of claims 1 to 17, wherein the progress tracking application is further configured to generate a report, the report comprising at least the stored information and/or summary of the progress of the at least one student.

19. The progress tracking system of claim 18, wherein the progress tracking application is further configured to electronically send the report to at least one second user device.

20. A computer implemented method for displaying progress of at least one student by way of a graphical user interface (GUI) of an electronic apparatus comprising a display device, a processor and a memory, the method comprising:
inputting progress data of the at least one student using the apparatus;
tracking progress of the at least one student towards the at least one goal based on the progress data of the at least one student; and
executing the GUI and generating and displaying at least one indicator on the display device, the indicator providing visual indication of the progress of the at least one student.

21. The method of claim 20, wherein the method further comprises inputting at least one goal of the at least one student using the apparatus.

22. The method of claim 20 or 21, wherein the method further comprises establishing a connection with a server via a network, the server being configured to store information, the information comprising at least an identity information of the at least one student, the at least one goal of the at least one student and the progress data of the at least one student towards achieving the at least one goal.

23. The method of any one of claims 20 to 22, wherein the method further comprises generating and presenting a plurality of progress levels, the progress levels correlating to progress towards the at least one goal of the at least one student in the GUI.

24. The method of claim 23, wherein the method further comprises associating a point value to each of the progress levels.

25. The method of claim 24, wherein the method further comprises recording and presenting progress level information in the GUI, the progress level information relating to sequential progress or sequential regress of the at least one student from one level to another based on the point value.

26. The method of claim 25, wherein the at least one indicator is a progress bar, and the method comprises presenting the progress level information as the progress bar.

27. The method of any one of claims 20 to 26, wherein the method further comprises allowing an authorised user to change the at least one goal.

28. The method of claim 27, wherein the method further comprises allowing an or the authorised user to input progress data.

29. The method of any one of claims 20 to 28, wherein the method further comprises preventing an unauthorised user from assigning themselves a goal and/or updating progress data.

30. The method of any one of claims 20 to 29, wherein the method further comprises allowing the at least one student to submit the at least one goal for review.

31. The method of any one of claims 20 to 30, wherein the method further comprises displaying one or more of: the identity of the at least one student, overall progress achieved by the at least one student, remaining progress to be achieved by the at least one student to reach the at least one goal, a percentage value of the overall points achieved by the at least one student in, and/or information regarding whether the at least one student is on or behind schedule to achieve the at least one goal within a given timeframe in the GUI.

32. The method of any one of claims 20 to 31, wherein the method further comprises presenting a notification alert in the GUI.

33. The method of any one of claims 20 to 32, wherein the method further comprises generating a plurality of indices based the progress of the at least one student,, each of the plurality of indices having its own plurality of levels and each of plurality of levels of the indices having a point value associated with it.

34. The method of any one of claims 20 to 32, wherein the method further comprises tracking progress with points, and displaying in the GUI at least one of: a total number of points that needs to be achieved for each of the at least one goals, total number of points already achieved for each of the at least one goals, and/or a percentage value of total number of points achieved for each of the at least one goals.

35. The method of any one of claims 20 to 34, wherein the method further comprises providing a visual indication of the progress of the at least one student for each of the at least one goals.

36. The method of any one of claims 20 to 35, wherein method further comprises generating a report, the report comprising at least the stored information and/or summary of the progress of the at least one student.

37. The method of claim 36, wherein the method further comprises electronically sending the report to at least one second device.

38. An apparatus for displaying progress of at least one student by way of a graphical user interface (GUI), the apparatus comprising:
a display device;
a processor; and
a memory storing computer readable instructions that when executed, cause the apparatus to perform the method as claimed in any one of claims 20 to 37.

39. A non-transitory computer program product embodied on a non-transitory computer readable medium, said computer program product comprising a program logic, which when executed on at least one computer processor perform the method as claimed in any one of claims 20 to 37.
